(19) United States
(12) Patent Application Publication
(10) Pub. No.: US 2009/0132999 A1
(43) Pub. Date: May 21, 2009

(54) Secure and fault-tolerant system and method for testing a software patch

(75) Inventor: Gustavo De Los Reyes, Fair Haven, NJ (US)

Correspondence Address: AT&T CORP., ROOM 2A207, ONE AT&T WAY, BEDMINSTER, NJ, 07921, US

(73) Assignee: AT&T Corp.

(21) Appl. No.: 11/986,536

(22) Filed: Nov. 21, 2007

(51) Int. Cl. G06F 9/44; G06F 9/445

(52) U.S. Cl. 717/124; 717/168

(57) ABSTRACT

Disclosed is a system and method for testing a software patch. An input is provided to a computer already patched with the software patch and a computer not yet patched with the software patch (i.e., an unpatched computer). A response to the input is generated by each computer. A comparator compares the responses to determine if the responses from each computer are the same. If the responses are the same, then the patch is installed on the previously unpatched computer.

### BACKGROUND OF THE INVENTION

The present invention is generally directed to computer systems and more particularly to testing software patches.

Security vulnerabilities of software applications are typically found after a software application has been deployed. If exploited, the security vulnerability can lead to a computer crash, service disruptions, divulging of personal data, etc. As a result, once a security vulnerability is found, software application manufacturers typically want to remove or mitigate the vulnerability as quickly as possible.

To remove a software vulnerability in a software application, a software patch is applied to the software application. A software patch is code designed to fix one or more vulnerabilities introduced by a software application. A patch removes or mitigates a vulnerability so that the vulnerability cannot be successfully exploited.

A software patch, however, is not typically deployed; or loaded onto a “production” server (i.e., a server that is providing service to customers) until the patch has been thoroughly tested (e.g., in a computer lab). Testing ensures that the patch mitigates or removes the vulnerability and that it does not cause further problems. For example, a patch that removes a first vulnerability in a software application but introduces a second vulnerability or execution errors in the software application is not deployed. When a software patch removes the first vulnerability but does not introduce any additional errors or vulnerabilities, the software patch can be deployed.

Although the testing of a patch usually reduces the number of errors and vulnerabilities that are introduced by the patch, the testing itself may cause problems. For example, the time needed to test a patch before the patch can be deployed may be significant. Until the patch is deployed, computers executing the software application have a (potentially known) vulnerability. Thus, the longer the testing takes, the longer the vulnerability of the software application can be exploited.

Additionally, although software manufacturers often test a software patch on a computer system that is similar to a production computer system, there are often differences. For example, a testing system may not be operating on the same scale as a production system and/or may not have the same hardware components and/or software modules as the production system. These differences may result in the software patch executing correctly on the test system but causing errors or introducing additional vulnerabilities on the production system.

Therefore, there remains a need to more accurately, efficiently and effectively test a software patch.

### BRIEF SUMMARY OF THE INVENTION

Rather than exposing a software patch to inputs provided to a production system only after testing the software patch, the software patch is instead tested in parallel with execution of the production system and is exposed to the same inputs that are provided to the production system.

In accordance with an embodiment of the present invention, a software patch is applied to (i.e., installed on) a patched computer. Inputs are provided to the patched computer and an unpatched computer. Responses to the inputs are generated by each computer. A comparator compares the responses to determine if the responses from each computer are the same. If the responses are the same, then the patch is installed on the previously unpatched computer.

If the unpatched computer's responses to the inputs are different than the patched computer's responses (to the same inputs), then further investigation typically occurs. An investigation occurs because either the patch is not working properly (e.g., introducing additional problems) or an attack may be occurring and the vulnerability is being exploited. In one embodiment, the investigation may result in the patch being updated.

In one embodiment, a predetermined number of inputs are provided to each of the computers (i.e., the patched computer and the unpatched computer). The computers each generate responses to the inputs. The comparator compares each of the computer's responses and generates an output indicating that the software patch can be installed on the previously unpatched computer only when a predetermined number of the responses (e.g., ten out of ten response pairs) are the same.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a system having an unpatched computer and a patched computer in accordance with an embodiment of the present invention;

FIG. 2 is a flowchart illustrating the steps performed by a comparator to test a patch installed on the patched computer before the patch is installed on the unpatched computer in accordance with an embodiment of the present invention; and

FIG. 3 is a high level block diagram of a computer which may be used to implement the unpatched computer, the patched computer, and/or the comparator in accordance with an embodiment of the present invention.

### DETAILED DESCRIPTION

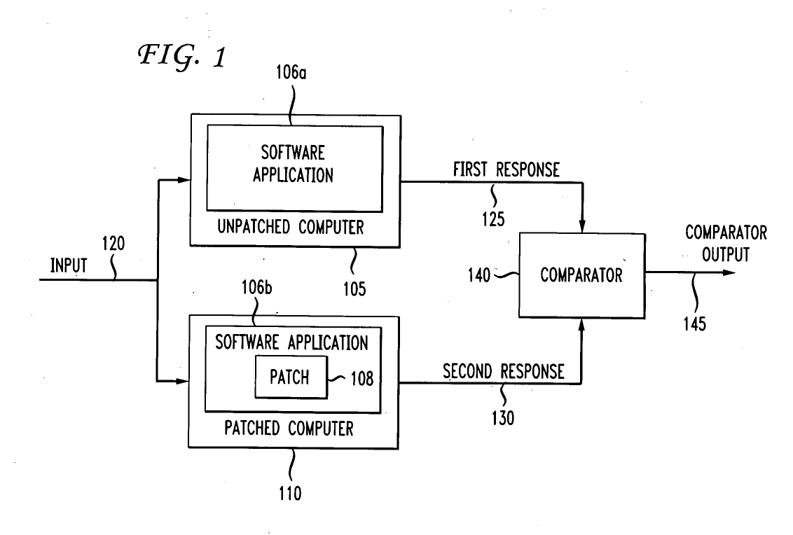

Referring to FIG. 1, an unpatched “production” computer 105 (referred to below as unpatched computer 105) is a computer that is executing software and receiving inputs (e.g., from one or more users). In one embodiment, the unpatched computer 105 completes transactions associated with the inputs, or responds to the inputs. Suppose that a software application executing on the unpatched computer 105 has a vulnerability (e.g., a computer “bug”). For example, software application 106a can be exploited via a vulnerability.

To remove the vulnerability, a software patch, such as software patch 108, is developed. Before installing the software patch on the unpatched computer 105, software patch 108 is installed on a patched computer 110 (e.g., software application 106b executing on patched computer 110 is updated with the software patch 108). In one embodiment, the patched computer 110 is a duplicate of the unpatched computer 105 (except for the patch 108). The patched computer 110 may be a duplicate of the unpatched computer 105 because, except for the patch 108, the patched computer 110 can be executing the same software (e.g., software application 106b) as the unpatched computer 105 (e.g., software application 106a) and can have the same hardware, such as the same amount of memory (e.g., RAM), the same hard drive(s), etc. This embodiment is advantageous because the patch 108 is tested on a system that is identical to the unpatched, production computer 105. This results in a more accurate test.

Each computer 105, 110 may be a desktop computer, a laptop computer, a server (e.g., a web server), or any other computing device. In one embodiment, computers 105, 110 are the same machine. In this embodiment, the software applications 106a, 106b are software applications executing on the same hardware but appear to be executing on different hardware via virtualization.

To test the software patch 108, one or more inputs (or queries) normally provided to the unpatched computer 105 are also provided to the patched computer 110. Input 120 may be, for example, a request from a client device (e.g., for a particular web page), an output from another computer, a user input, an output from a sensor, etc. The unpatched computer 105 generates a first response 125 to the input 120 and the patched computer 110 generates a second response 130 to the input 120.

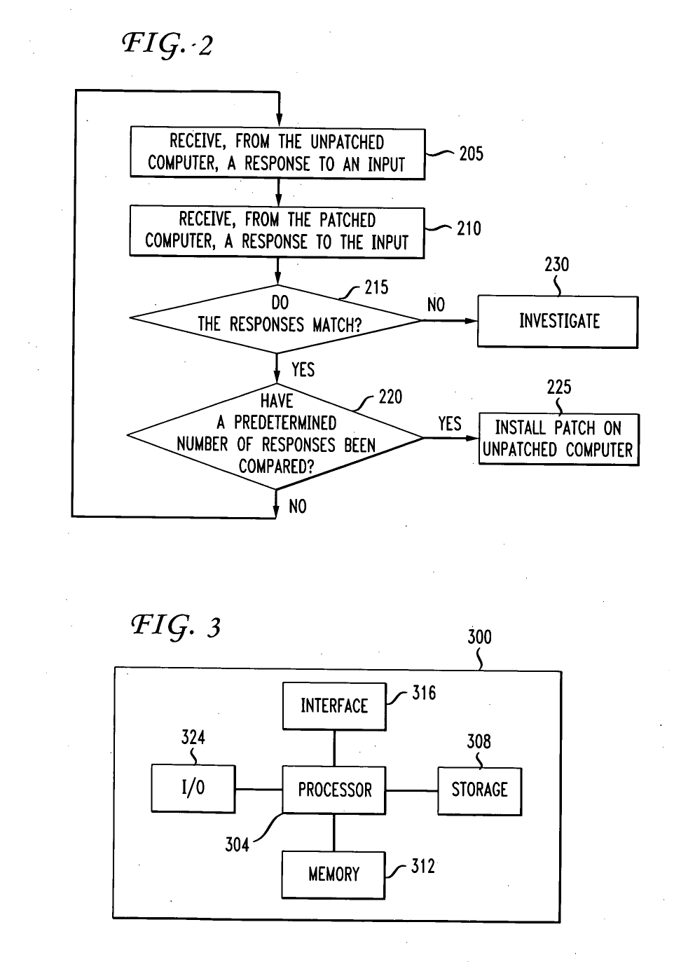

FIG. 2 is a flowchart illustrating the steps performed by a comparator 140. The comparator 140 can be implemented in hardware or software. The comparator may be operating or executing in a separate computer or may be operating or executing in the unpatched computer 105 or the patched computer 110. Comparator 140 receives, from the unpatched computer 105, the first response 125 (step 205). The comparator 140 receives, from the patched computer 110, the second response 130 (step 210). The comparator 140 compares the responses 125, 130 to determine if the responses 125, 130 match (step 215).

In one embodiment, if the responses 125, 130 match in step 215, the comparator 140 determines if a predetermined number of responses have been compared in step 220. For example, ten inputs can be provided to the unpatched computer 105 and the patched computer 110 to generate ten first responses 125 and ten second responses 130. Each respective response 125, 130 is compared and, if a predetermined number of matches occur (e.g., ten matches out of ten comparisons), then the software patch is installed on the unpatched computer 105 in step 225.

If one or more of the respective responses 125, 130 do not match, the unpatched computer 105 may be configured to block the transaction associated with the input 120. Blocking the transaction associated with the input 120 means not fulfilling the request associated with the input 120. For example, the unpatched computer 105 may not transmit a requested web page to the client device. Alternatively, the unpatched computer 105 may be configured to complete the transaction associated with the input 120. In one embodiment, when the responses do not match, an administrator is notified (e.g., via an alarm or an email). An investigation is then performed in step 230 to determine whether an attack is in progress or the patch is “bad” (i.e., the patch causes errors/problems or introduces one or more additional vulnerabilities). In one embodiment, a system administrator performs the investigation. Alternatively, the investigation occurs automatically. The investigation may involve reviewing the input 120 and the responses 125, 130 to determine why the responses 125, 130 differed. In one embodiment, the investigation causes someone to look at and/or update the patch, or download a new version of the patch onto the patched computer 110 (automatically or manually).

In one embodiment, the comparator 140 outputs a comparator output 145 to denote whether the software patch can be installed on the unpatched computer 105. This output 145 may be generated after one match occurs or after a predetermined number of response matches occur.

As described above, the patch is not tested “off-line” like prior-art patch testing, but is rather tested in parallel with the execution of the unpatched computer 105. This parallel testing results in a secure and fault-tolerant deployment of software patches. The testing is secure because, if there is a difference that is caused by an attack, action can be taken to prevent or at least discover the attack. The testing is also fault tolerant because, if the patch causes an error, the patch is not (and has not yet been) installed on the unpatched computer 105. The patch is only installed on the previously unpatched computer 105 after verification that the patch does not affect the output of a patched computer 110. Thus, the unpatched computer 105 is not affected by faults introduced by a patch.

FIG. 3 shows a high level block diagram of a computer 300 which may be used to implement first computer 105, second computer 110, and/or comparator 140. The computer 300 can, for example, perform the steps described above (e.g., with respect to FIG. 2). Computer 300 contains a processor 304 which controls the overall operation of the computer by executing computer program instructions which define such operation. The computer program instructions may be stored in a storage device 308 (e.g., magnetic disk, database) and loaded into memory 312 when execution of the computer program instructions is desired. Thus, the computer operation will be defined by computer program instructions stored in memory 312 and/or storage 308 and the computer will be controlled by processor 304 executing the computer program instructions. Computer 300 also includes one or more interfaces 316 for communicating with other devices. Computer 300 also includes input/output 324 which represents devices which allow for user interaction with the computer 300 (e.g., display, keyboard, mouse, speakers, buttons, etc.). One skilled in the art will recognize that an implementation of an actual computer will contain other components as well, and that FIG. 3 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for testing a software patch comprising:
receiving, from an unpatched computer, a plurality of responses to a plurality of inputs;
receiving, from a patched computer, a plurality of responses to said plurality of inputs;
comparing said plurality of responses from said unpatched computer and said plurality of responses from said patched computer; and
determining whether to install said software patch on said unpatched computer based on said comparison.

2. The method of claim 1 further comprising installing said software patch on said unpatched computer when at least some of said plurality of responses from said unpatched computer are the same as at least some of said plurality of responses from said patched computer.

3. The method of claim 1 further comprising updating said software patch when a response in said plurality of responses from said unpatched computer is different than a corresponding response in said plurality of responses from said patched computer.

4. The method of claim 1 further comprising performing an investigation when a response in said plurality of responses from said unpatched computer is different than a corresponding response in said plurality of responses from said patched computer.

5. The method of claim 4 wherein said performing an investigation further comprises reviewing said plurality of inputs, said plurality of responses from said patched computer, and said plurality of responses from said unpatched computer.

6. The method of claim 4 wherein said performing an investigation further comprises analyzing at least one of said patch, said patched computer, and said unpatched computer.

7. The method of claim 1 wherein said determining whether to install said software patch on said unpatched computer further comprises determining whether a predetermined number of responses have been compared.

8. The method of claim 1 wherein said determining whether to install said software patch on said unpatched computer further comprises comparing a portion of said plurality of responses from said unpatched computer and a portion of said plurality of responses from said patched computer.

9. A method for installing a software patch on an unpatched computer comprising:
providing inputs to a patched computer and an unpatched computer;
comparing responses from said patched and unpatched computers to said inputs; and
installing said software patch on said unpatched computer if at least a plurality of said responses from said patched computer and said unpatched computer match.

10. The method of claim 9 further comprising performing an investigation if at least one of said responses from said patched computer and said unpatched computer do not match.

11. The method of claim 10 wherein said performing an investigation further comprises analyzing at least one of said patch, said unpatched computer, and said patched computer.

12. The method of claim 10 wherein said performing an investigation further comprises reviewing said inputs, said responses from said patched computer, and said responses from said unpatched computer.

13. The method of claim 9 further comprising updating said patch if at least one of said responses from said patched computer and said unpatched computer do not match.

14. An apparatus for testing a software patch comprising:
means for receiving, from an unpatched computer, a plurality of responses to a plurality of inputs;
means for receiving, from a patched computer, a plurality of responses to said plurality of inputs;
means for comparing said plurality of responses from said unpatched computer and said plurality of responses from said patched computer; and
means for determining whether to install said software patch on said unpatched computer based on said comparison.

15. The apparatus of claim 14 further comprising means for installing said software patch on said unpatched computer when at least some of said plurality of responses from said unpatched computer are the same as at least some of said plurality of responses from said patched computer.

16. The apparatus of claim 14 further comprising means for performing an investigation when a response in said plurality of responses from said unpatched computer is different than a corresponding response in said plurality of responses from said patched computer.

17. The apparatus of claim 16 wherein said means for performing an investigation further comprises means for reviewing said plurality of inputs, said plurality of responses from said patched computer, and said plurality of responses from said unpatched computer.

18. The apparatus of claim 16 wherein said means for performing an investigation further comprises means for analyzing at least one of said patch, said patched computer, and said unpatched computer.

19. The apparatus of claim 14 wherein said means for determining whether to install said software patch on said unpatched computer further comprises means for determining whether a predetermined number of responses have been compared.

20. A system for installing a software patch on an unpatched computer comprising:
an unpatched computer configured to receive a plurality of inputs and provide responses to said plurality of inputs;
a patched computer configured to receive said plurality of inputs and provide responses to said plurality of inputs; and
a comparator configured to compare said responses to said plurality of inputs from said patched computer and said unpatched computer and further configured to determine whether to install said software patch on said unpatched computer based on said comparison.
